(19) United States
(12) Patent Application Publication
(10) Pub. No.: US 2026/0016894 A1
(43) Pub. Date: Jan. 15, 2026

(54) MUSCLE ACTIVATION DETECTION APPARATUS

(71) Applicant: The University of Hong Kong, Pokfulam (CN)

(72) Inventors: Ning Xi, Pokfulam (CN); Wenbo Yuan, Kennedy Town (CN); Ziqin Ling, Hong Kong (CN); Jiangcheng Chen, Sham Shui Po (CN); Yafei Zhao, Hong Kong (CN)

(21) Appl. No.: 19/264,082

(22) Filed: Jul. 9, 2025

Related U.S. Application Data
(60) Provisional application No. 63/671,386, filed on Jul. 15, 2024.

(51) Int. Cl. G06F 3/01; B25J 9/16; B25J 13/08

(52) U.S. Cl. CPC G06F 3/015; B25J 9/1633; B25J 13/087

(57) ABSTRACT

A muscle activation detection apparatus includes a first surface electromyogram (sEMG) sensor arranged to receive a first sEMG signal associated with a user; a second SEMG sensor arranged to receive a second sEMG signal associated with the user; and a processing unit configured to determine the muscle contraction of the user based on the first and second sEMG signals.

### TECHNICAL FIELD

The invention relates to a muscle activation detection apparatus, in particular but not limited to a surface electromyogram (sEMG) sensing based muscle activation detection apparatus.

### BACKGROUND

Nowadays, physical sensors such as IMUs and pressure sensors are widely used in robot pose detection and control. Compared to physical sensors, biological signals have inherent advantages in detecting human activity and controlling wearable robots that coordinate with human beings. In terms of human-robot collaboration, surface electromyogram (sEMG) is one of the efficient biological signals to obtain.

To assist the activities of daily living (ADL) task, wearable robots such as exoskeletons, soft wearable robots and prothesis robots have been widely developed. One of the challenges of the wearable robots is the synchronization between human muscle and artificial muscle or actuator, which means that the intention of human action needs to be detected instantaneously.

### SUMMARY OF THE INVENTION

In accordance with a first aspect, there is provided a muscle activation detection apparatus, comprising:
a first surface electromyogram (sEMG) sensor arranged to receive a first sEMG signal associated with a user;
a second sEMG sensor arranged to receive a second sEMG signal associated with the user; and
a processing unit configured to determine the muscle contraction of the user based on the first and second sEMG signals.

In one example the muscle activation detection apparatus further comprises a phase comparator arranged to compare the phase difference between the first and second sEMG signals so as to determine the real-time muscle contraction.

In one example the muscle in an inactive state is represented by the sEMG signals detected zero phase difference at the two sides of IZ and the muscle in an activated state is represented by the sEMG signals detected non-zero phase difference of difference places or inverse phase difference at two sides of IZ respectively.

In one example the relative distance between the first and second sEMG sensors on a muscle fiber is in a positive correlation with the phase difference between the first and second sEMG signals.

In one example the processing unit is configured to transmit an output signal associated with a force or torque parameter of a robot device based on the determined degree of muscle contraction.

In one example the ON-OFF control of the robot device is determined based on the start and end of the determined muscle contraction.

In one example the sEMG sensor further comprises a soft electrode arranged to physically contact the skin surface of the user.

In one example the muscle activation detection apparatus further comprises an amplifier configured to amplify electromyographic signal to a measurable level.

In one example the muscle activation detection apparatus further comprises a high pass filter configured to perform high pass filtering on the sEMG signal.

In one example the muscle activation detection apparatus further comprises a wireless radio frequency module configured to control a remote robot device.

In one example the muscle activation detection apparatus, further comprising a CAN chip module configured to control a remote robot device by wire.

In one example the muscle activation detection apparatus, further comprising a serial communication module to monitor the data and transfer the data to a remote robot device.

In one example the muscle activation detection apparatus further comprises a trigger generating unit in signal communication with the phase comparator and the trigger generating unit is configured to trigger a robot device based on the output from the phase comparator associated with the compared phase difference between the first and second sEMG signals.

In one example the trigger generating unit further comprises a mixer configured to mix the first and second sEMG signals to generate a mixed output signal.

In one example the trigger generating unit is configured to detect a change in the mixed output signal corresponding to an onset of muscle activation.

In one example the trigger generating unit is configured to generate a binary trigger signal in response to a detected change in the mixed output signal.

In one example the binary trigger signal is indicative of a transition from an inactive muscle state to an activated muscle state.

In one example the trigger generating unit is configured to perform a zero-crossing detection on the mixed output signal to generate the binary trigger signal.

In one example the sEMG sensor further comprises a linear electrode arranged to detect an IZ location and a location in contact with a preamplifier of the sEMG sensor.

In one example the linear electrode further comprises a linear electrode array formed by the first sEMG sensor and the second sEMG sensor and arranged to be placed along a length of the muscle.

In one example the linear electrode comprises multiple sEMG sensors spaced from each other at a uniform distance.

The term “comprising” (and its grammatical variations) as used herein are used in the inclusive sense of “having” or “including” and not in the sense of “consisting only of”.

The term “user” as used herein refers to human wearer, or other creatures such as pets and animals.

It is to be understood that, if any prior art information is referred to herein, such reference does not constitute an admission that the information forms a part of the common general knowledge in the art, in any country.

### BRIEF DESCRIPTION OF THE DRAWINGS

Embodiments of the present invention will now be described, by way of example, with reference to the accompanying drawings in which:

FIG. 1A illustrates a wireless muscle activation detection system overall design in accordance with one example embodiment of the present invention.

FIG. 1B illustrates the existence of the IZ position in accordance with one example embodiment of the present invention.

FIG. 1C shows the relationship between various parameters during waveform propagation.

FIG. 1D shows a linear electrode model and a physical electrode in accordance with one example embodiment of the present invention.

FIG. 1E shows a slice of surface electromyographic (sEMG) signal collected by a linear electrode in accordance with one example embodiment of the present invention.

FIG. 1F shows the scenario of a subject wearing a linear electrode in accordance with one example embodiment of the present invention.

FIG. 1G shows the processing steps for muscle activation detection using electromyographic signals on opposite sides of the IZ position.

FIG. 2 illustrates an ON-OFF control and force tracking implementation diagram in accordance with one example embodiment of the present invention.

FIG. 3 illustrates an idealized model for the placement of neuromuscular junctions (NMJ) and electrodes in accordance with one example embodiment of the present invention.

FIG. 4 illustrates the phase and magnitude comparison output for different electrodes distances.

FIG. 5 depicts an ultrathin soft electrode design and manufactured sample in accordance with one example embodiment of the present invention.

FIG. 6 depicts an overall diagram of wireless sEMG and muscle activation detection sensors in accordance with one example embodiment of the present invention.

FIG. 7 depicts the electromyographic signals and spectral distribution maps collected using soft electrodes in accordance with one example embodiment of the present invention.

FIG. 8 depicts a wireless sEMG sensor in accordance with one example embodiment of the present invention and a commercial wireless sEMG sensor.

FIG. 9 depicts the baseline noise of wireless EMG sensor and commercial sensor.

FIG. 10 depicts the collected sEMG signals and spectrogram.

FIG. 11 depicts the WL, SSC, ZC, MAV, and MDF of EMG signal from the two types of sensors.

FIG. 12 depicts linear array electrode configuration scheme and collected signals.

FIG. 13 depicts sEMG signals collected on both sides of the IZ position.

FIG. 14 depicts phase output of two-phase sEMG signal detection.

FIG. 15 depicts two-phase trigger comparison with traditional method.

### DETAILED DESCRIPTION OF THE PREFERRED EMBODIMENTS

Meanwhile, muscle activation detection has a wide range of applications in the fields of sports and health, rehabilitation training, and medical diagnosis.

The present invention relates to a novel sensor that can collect surface electromyographic signals and detect muscle activation status through new technologies. For instance, the present invention particularly relates to a wireless muscle activation detection sensor.

In addition, to make the sensor more comfortable to wear, the inventors of the present invention have developed a thin soft electrode. Using soft electrodes for muscle activation detection in the aforementioned areas will be more comfortable and flexible.

In order to integrate the sEMG sensor into the robot control system, the signal amplifier circuit needs to be developed. Additionally, a trigger system based on that sensor also needs to be developed.

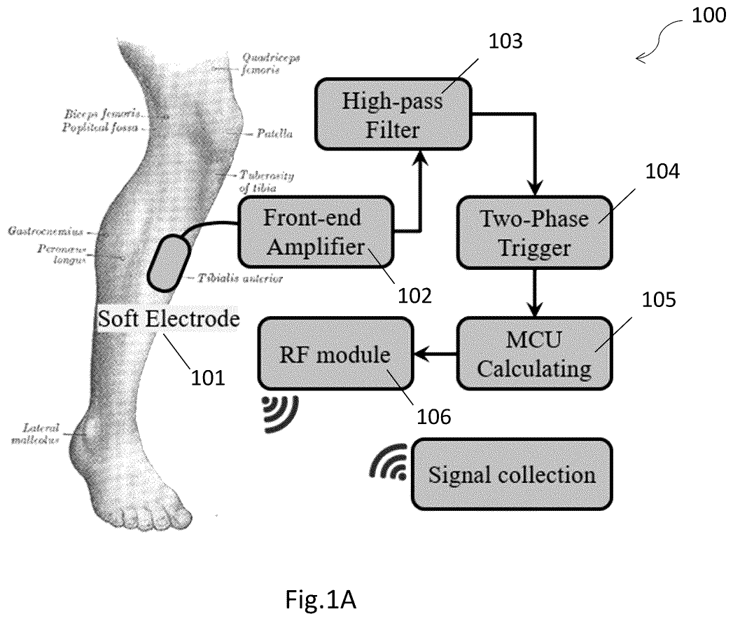

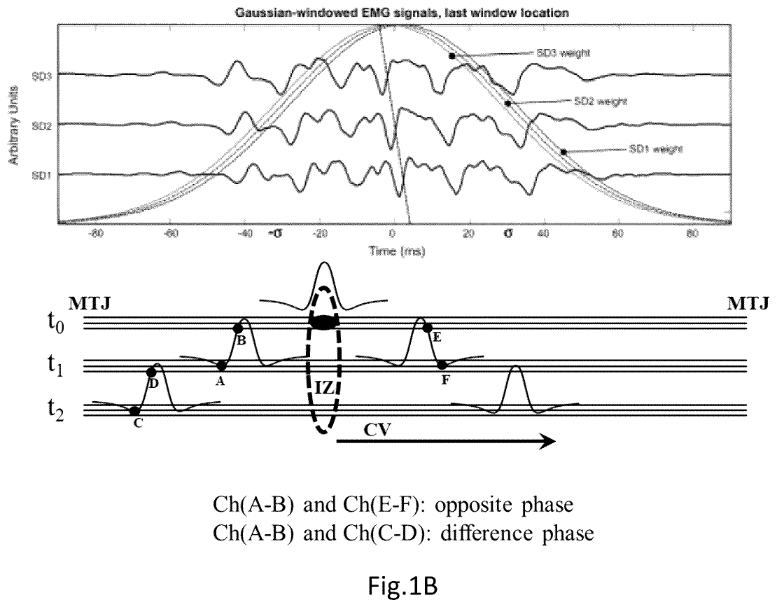

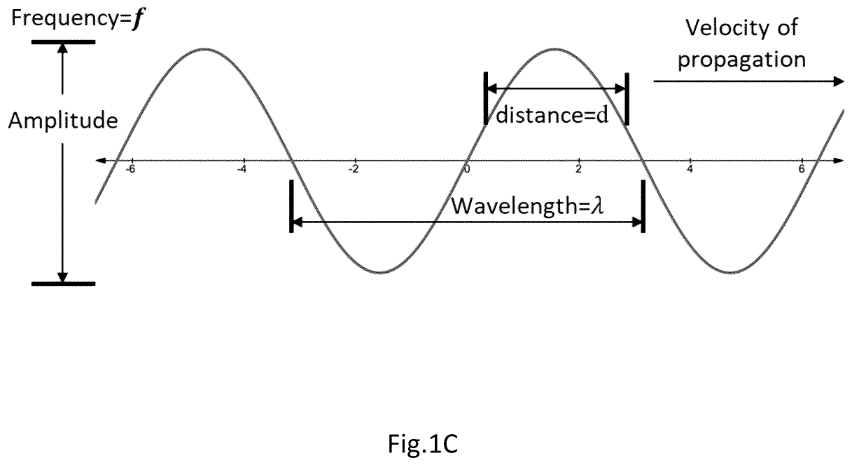

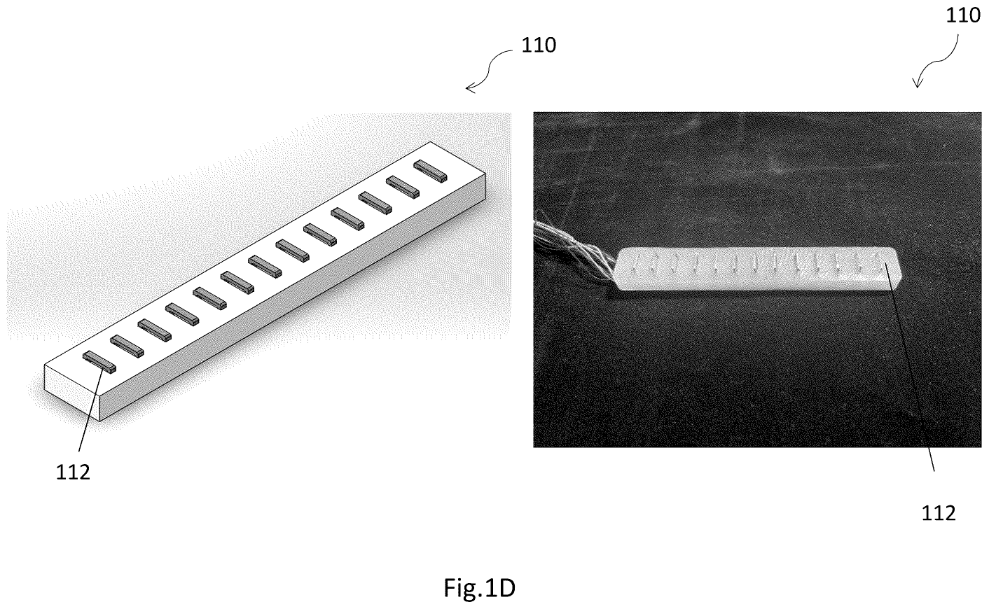

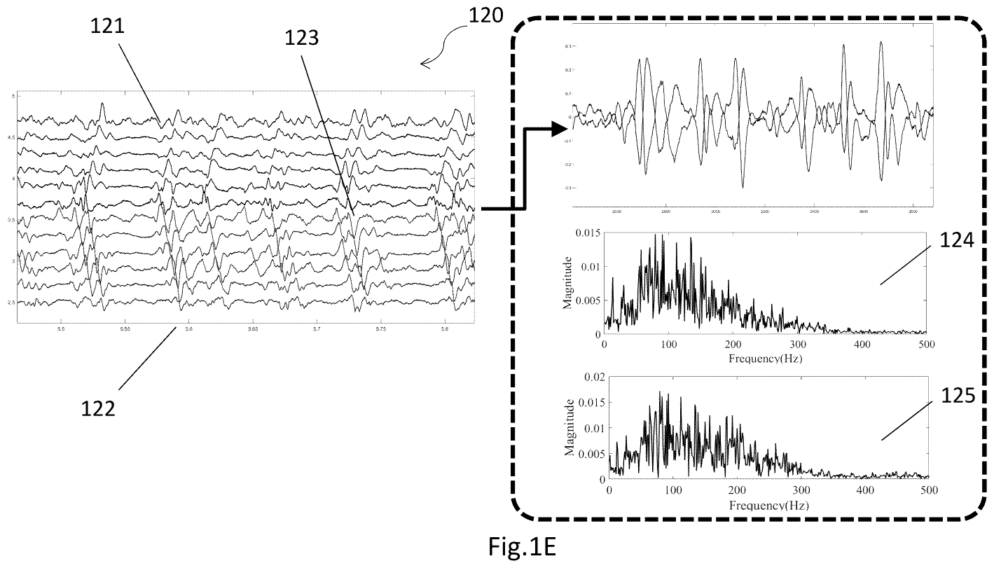

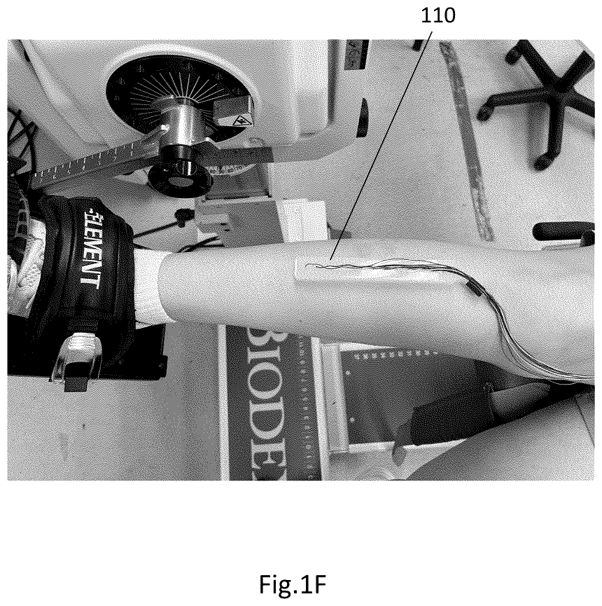

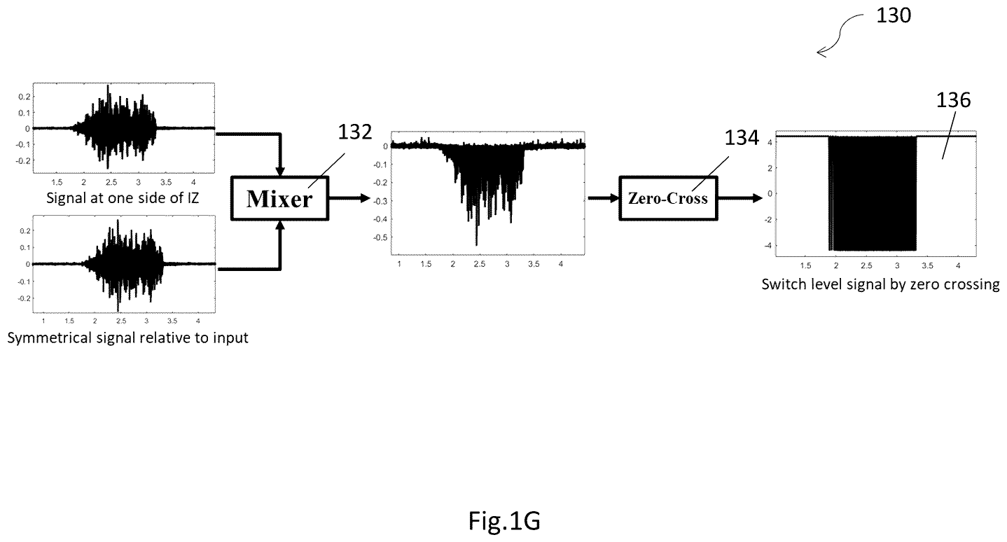

The block diagram of the overall design in accordance with one example embodiment of the present invention is shown in FIG. 1A. Overall, the sensor 100 in this invention may comprise the following components: soft electrode 101, front-end amplifier 102, back-end filtering circuit 103, phase comparator 104, AD converter, MCU 105, power module, wireless radio frequency module 106, Control Area Network (CAN) communication chip, and external connection interface.

The functions of each part are: soft electrodes 101 are used to attach to the surface of the skin to collect surface electromyographic (sEMG) signals; The front-end amplifier 102 is used to amplify weak signals to a measurable level; The backend filtering circuit 103 is used to remove power frequency noise and low-frequency interference; The phase comparator 104 is used to detect the phase difference information of surface electromyography; AD converter is used to read data to MCU 105 and MCU 105 is a data processing and control unit; The power module supplies power to various circuit components; Control Area Network (CAN) communication chip is used to communicate with other controllers; and External connection interfaces are used for extending other functions. This sensor 200 can be applied in areas that require muscle detection such as robot automatic control, sports and fitness, medical diagnosis, and rehabilitation medicine, etc.

Electromyographic signals are physiological signals sent from the nervous system to the muscles and control muscle movement. This physiological signal can generate electromotive potential on the surface of the skin. The use of high-precision sensors and equipment can read this weak electromotive potential. In this invention, the inventors have designed a complete system from electrodes on the surface of the skin to circuits for signal generation and calculation.

In one example embodiment, the present invention relates to a system for obtaining the amplitude and phase differences from the sEMG sensors to know the activated state of the muscle.

Muscle activation means that muscles contract and generate torque on joints, thereby driving limb movement. In this invention, there is a sensor that detects the degree of muscle activation, which can output raw signals and RMS signals so as to obtain muscle activation time based on raw signals with opposite characteristics. The principle of detecting muscle activation relies on the reverse phenomenon of the original signal. The phase difference depends on the application of linear electrodes. Accordingly, the activated state of the muscle can be indicated by the amplitude and the phase differences.

The skeletal muscles of the human body receive action commands from the brain through neuromuscular junctions (NMJ), which are nerve impulses. The neuromuscular junction (NMJ) is connected to a position in the muscle, and FIG. 1B illustrates the existence of the innervation zone (IZ) position.

After receiving signals through neuromuscular junctions, muscles will reflect the IZ area on the surface of the skin. The electromyographic signal propagates from this area to both sides, starting from the IZ position and ending at the musculotendinous junction (MTJ). From one side of the IZ position, due to the propagation of electromyographic signals, phase differences may occur when detecting signals at different locations. From both sides of the IZ position, the signals at equivalent positions will exhibit opposite phenomena.

The detection of electromyographic signals relies on differential electrodes. When using electrodes for sEMG signal acquisition, if the electrodes are placed in the IZ position, the collected sEMG signal will be too small due to the characteristic of the signal transmission from the IZ position to both sides. Different electrode placement positions will result in different signals. If the IZ position is considered as a signal source, there will be a phase difference when the electrodes are arranged on one side, while when they are symmetrically arranged on both sides, the signal will have opposite phases.

In FIG. 1B, ABCDEF are the detected points. If the electrode method is differential AB and differential CD, then the two EMG signals obtained will have a phase difference. If it is the difference between AB and EF, then the two signals obtained will be reversed.

By utilizing this feature, the phase of two signals can be used as the onset point for muscle contraction, thereby achieving detection of human action intention.

FIG. 1C shows the relationship between various parameters during waveform propagation. In the case where frequency, velocity, and wavelength parameters remain constant, phase difference is only proportional to distance. The propagation of electromyographic signals in muscles has a certain attenuation, but it can be ignored, so the parameters of its waveform will not change. Linear electrodes can be used to find the IZ position.

FIG. 1D shows the design of a linear electrode 110 and a physical image of the electrode 110 in accordance with one example embodiment of the present invention. The linear electrode 110 is provided with a plurality of sEMG sensors 112 on the electrode 110 and spaced from each other at a uniform distance. This linear electrode 110 can be used to find the IZ location of skeletal muscles.

FIG. 1E shows the surface electromyographic (sEMG) signals collected using this electrode 110. In FIG. 1E, it can be observed that the blue and red lines 121, 122 next to the black line 123 in the middle are opposite. After its separate plot 124, 125, the frequency spectrum analysis shows the same frequency distribution for both surface electromyographic (sEMG) signals. The middle location of the inverse signals at this linear electrode 110 is the IZ location.

FIG. 1F shows the scenario of the subject using a linear electrode 110. The linear electrode 110 is attached to the skin along the direction of the muscle, and each protruding small piece enters the EMG sensor 112. By differentiating between the front and back small pieces, an EMG signal can be obtained. By using this linear electrode 110, a total of 12 signals corresponding to the phase difference between each of the two adjacent EMG sensors 112 can be obtained. From these signals, two opposite signals can be obtained, and then the operation process in FIG. 1G can be carried out.

FIG. 1G shows the processing steps for muscle activation detection using electromyographic signals on opposite sides of the IZ position. After determining the IZ position mentioned above, two opposite signals are detected and transmitted to the mixer 132 to generate a mixed frequency signal. The mixed signal when the muscle is activated will be negative, while the mixed signal when the muscle is not activated will be positive. By using this feature to perform zero crossing analysis 134 on the mixed frequency signal, the moment and time period of muscle activation can be obtained. This image reflects the process of processing reverse signals. After mixing and zero crossing comparison, the switch level signal 136 obtained can be used to represent the activation time of muscles.

A wireless EMG sensor suitable for control of wearable exoskeleton is designed and evaluated. The sensor applies an analog-front-end (AFE) chip to convert the raw sEMG signal to the sampled sEMG signal. An integrated right leg driven (RLD) circuit is used for compensating the power line noise of sEMG signals. Moreover, the sensor meets requirements related to wearability, portability, size, ergonomics, and power consumption.

Key features show that the signal from the low-cost EMG system does not have significant differences compared to the commercial EMG system. However, most of the ADC chips used in these studies are built-in ADCs of MCU, in addition, there is a lack of compensation circuits for 50 Hz powerline noise.

To use the opposite phase sEMG signals to detect the intention of human limb movement, the first step is to use multi-channel sEMG sensors to verify the transmission of sEMG on the skin surface, resulting in phase delay between signals. Using the AD8302 chip and EMG sensor circuit mentioned above, phase detection and amplitude detection of two-phase sEMG signals can be achieved. By utilizing the phase difference of the opposite phase sEMG for human motion intention detection, the MCU computing power required for Raw signal processing is avoided, and its feature is an inevitable phenomenon during muscle contraction, thereby improving the accuracy of detection.

The phase comparison results of the opposite sEMG signals can provide good conditions for the ON-OFF control of wearable robots. The start and end of the signal, namely the start and end of muscle contraction, can be clearly reflected in the amplitude of the phase comparison. Therefore, by reading this signal with a microcontroller and conducting real-time high-frequency detection, the trigger signal of the robot's start within milliseconds can be obtained.

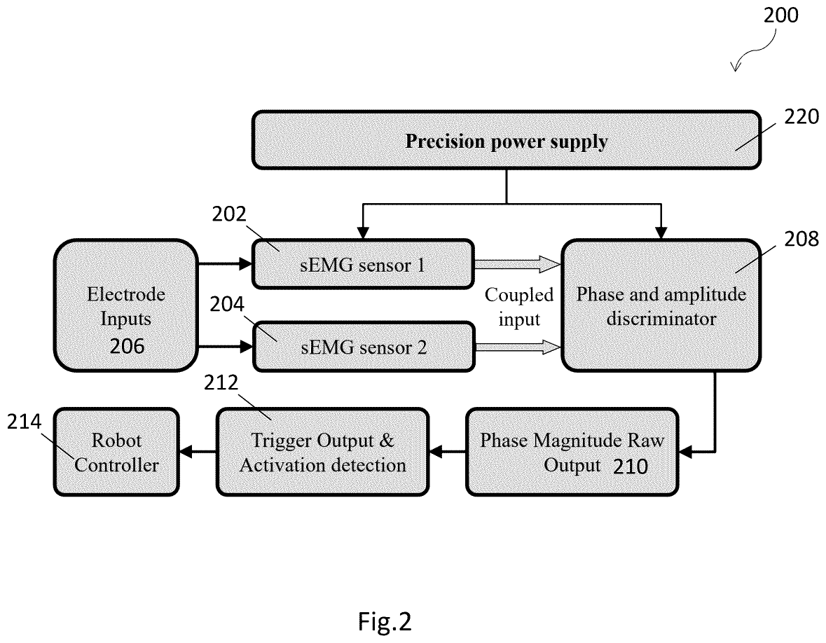

By calculating the raw signal obtained, the degree of muscle activation can be calculated, allowing the wearable robot to follow this activation level and provide a certain force or torque, so that the combined force between the human body and the wearable robot can reach the level of ADL action. The implementation scheme of the hardware realized trigger and activation detection system 200 is shown in FIG. 2.

In one example embodiment, the trigger and activation detection system 200 comprises a first sEMG sensor 202 and a second sEMG sensor 204 each arranged to physically contact the skin surface of the user and receive electrode inputs 206 from the skin surface of the user. Each of the outputs measured by the first sEMG sensor 202 and a second sEMG sensor 204 are coupled into a single input and transmitted to a phase and amplitude discriminator 208 for further data processing. The phase and amplitude discriminator 208 may compare the phase difference between the sEMG signals captured by the first sEMG sensor 202 and the second sEMG sensor 204 as well as amplify the phase difference between the electromyographic signal to a measurable level and generate a phase magnitude raw output 210, which may then further trigger the output and activation detection 212 to control a robot controller 214.

Advantageously, there is also provided a precision power supply 220 for supplying power to the first sEMG sensor 202, the second sEMG sensor 204 and the phase and amplitude discriminator 208.

The model of action potential for electromyographic signals can be simply represented as a triphasic shape, and its expression can be expressed as the second derivative of an exponential model. The expression Vₘ(z) is shown below.

$${V}_{m} ( z ) = {A ( λ z )}^{3} {e}^{- λ z} - B$$

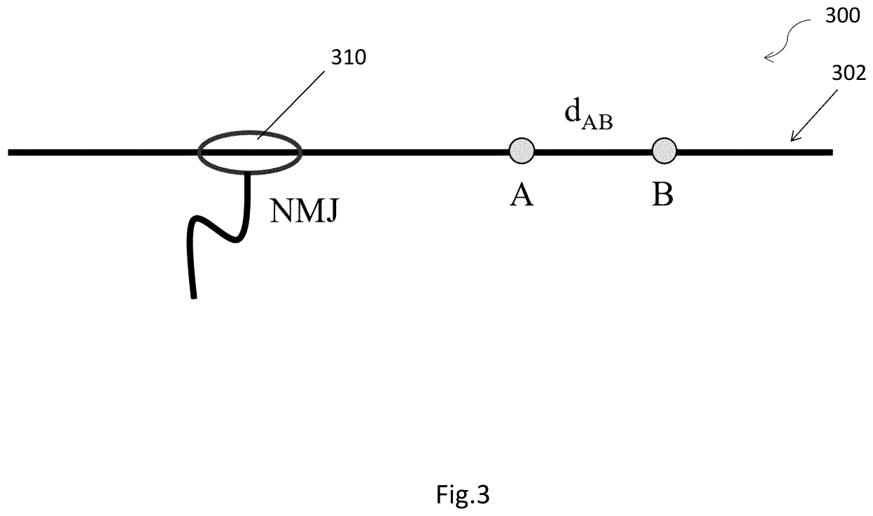

The expression for phase difference and an idealized model 300 is as shown in FIG. 3. Idealize the neuromuscular junction (NMJ) as a point 310 on the muscle fiber 302, and the electrode as two points A, B on the muscle fiber 302 at a distance of d_{AB}. Based on the expression of action potential, the phase difference when the signal is transmitted to two points AB can be obtained.

$$\{ \begin{matrix}{Z}_{B} = {Z}_{A} + {d}_{AB} \\ {V}_{m} ( {Z}_{B} ) - {V}_{m} ( {Z}_{A} ) = {A}_{W} sin ( ϕ ) \\ {V}_{m} ( z ) = {A ( λ z )}^{3} {e}^{- λ z} - B\end{matrix}$$

$$ϕ = arcsin [ \frac{A}{{A}_{W}} \cdot {λ}^{3} \cdot {e}^{- λ {Z}_{A}} ( {Z}_{A}^{3} - {( {Z}_{A} + {d}_{AB} )}^{3} {e}^{- λ {d}_{AB}} ) ]$$

According to the expression of phase difference, as the distance das between the two electrodes increases, its phase difference will gradually increase, indicating a positive correlation. To verify this hypothesis, experiments were conducted using a phase comparator and two-phase sEMG signals. The tested muscle is tibialis anterior (TA) muscle. The distances between electrodes are 18 mm, 55 mm, 75 mm, 105 mm, 125 mm, and 150 mm respectively.

TABLE 1
Phase difference at different electrodes distances

| Distance | | First | Second | Third | Average | Phase difference |
|---|---|---|---|---|---|---|
| 18 | mm | 1.6023 | 1.5962 | 1.6481 | 1.6155 | 0.1845 |
| 55 | mm | 1.4622 | 1.4058 | 1.4470 | 1.4383 | 0.3617 |
| 75 | mm | 1.3908 | 1.3600 | 1.4371 | 1.3960 | 0.4040 |
| 105 | mm | 1.3580 | 1.3518 | 1.3511 | 1.3536 | 0.4464 |
| 125 | mm | 1.2251 | 1.1933 | 1.2779 | 1.2321 | 0.5679 |
| 150 | mm | 0.9117 | 0.9727 | 0.9547 | 0.9463 | 0.8357 |

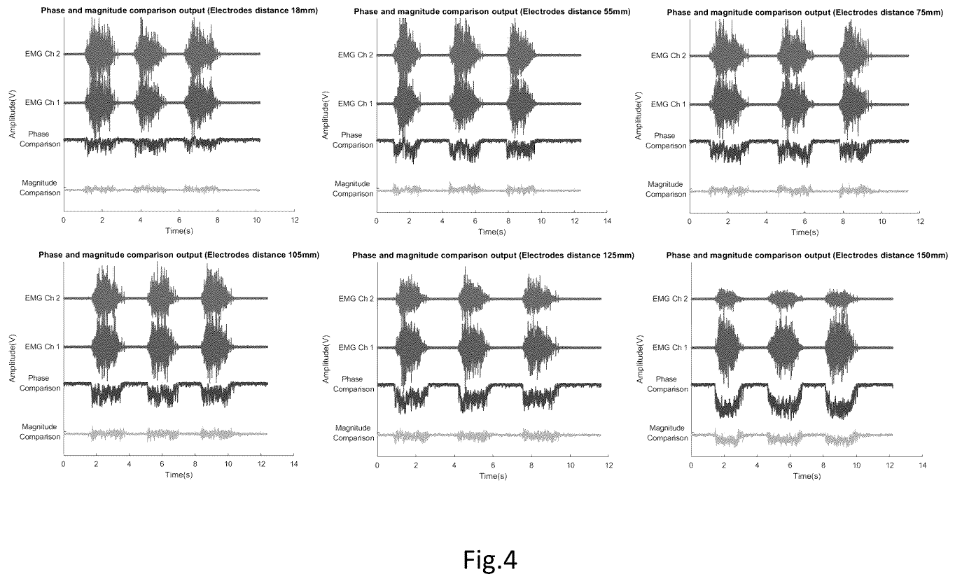

The experimental results are shown in FIG. 4. From the graph, it can be seen that there is a positive correlation between the phase output result and the distance between the electrodes.

The present invention first designs an sEMG sensor as the front-end detection circuit for implementing the functions of the present invention. It utilizes a high-precision instrument operational amplifier to detect and amplify weak electromyographic signals, and eliminates other physiological signals such as crosstalk and low-frequency electrocardiogram signals through the common mode suppression characteristics of the precision operational amplifier. After the EMG signal passes through the analog front-end, there will still be some low-frequency environmental noise such as 50 Hz power frequency interference mixed in. Therefore, the present invention designs an analog back-end filter, which mainly performs high pass filtering based on the frequency distribution of the sEMG signal in the 80-350 Hz range, in order to obtain a relatively pure sEMG signal. Due to the phase difference in the propagation of electromyographic signals on muscles, opposite phase sEMGs are used for real-time phase detection.

When the muscle is in an inactive state, the phase difference between the opposite phase sEMGs is zero or remains unchanged. When the muscle is in an activated state, the phase difference between the opposite phase sEMGs is non-zero or changes. By utilizing this characteristic, it is possible to accurately detect whether the muscle is in an activated state. The simulated front-end and back-end of the sEMG sensor designed simultaneously can detect the degree of muscle activation. The use of ADC chips enables data collection, MCU enables data transmission and processing, ESP32 microcontroller enables wireless data transmission, and CAN bus interface enables reliable wired data transmission. The activation status of muscles can provide a trigger for robots, and the degree of muscle activation can provide force tracking information for robots. Thus, solving the problem of using sEMG to accurately and in real-time control robots.

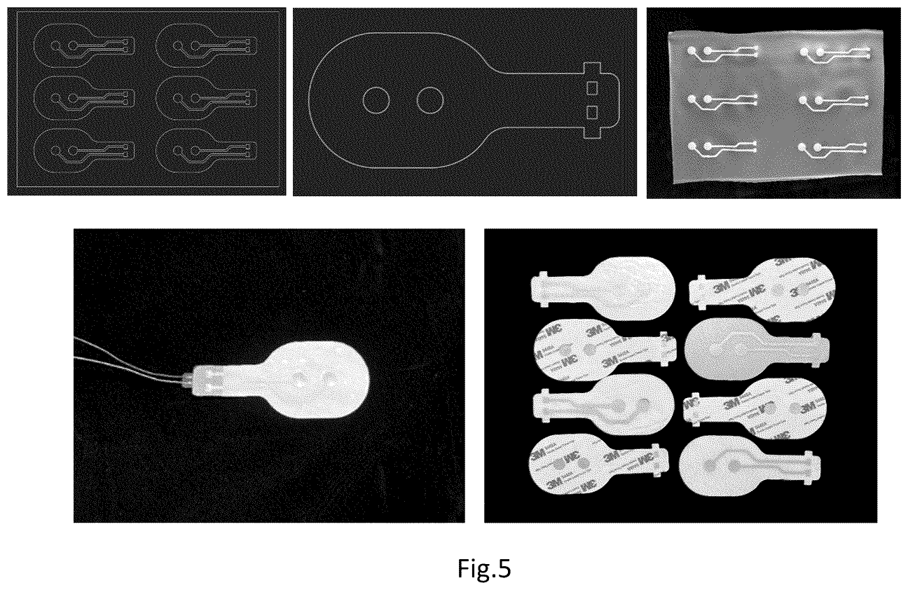

The design of ultra-thin soft electrodes mainly includes four parts, namely, TPU substrate, Ag/AgCl material printing circuit, double-sided adhesive, and electrode adapter plate. The design of each part and physical photo is shown in FIG. 5.

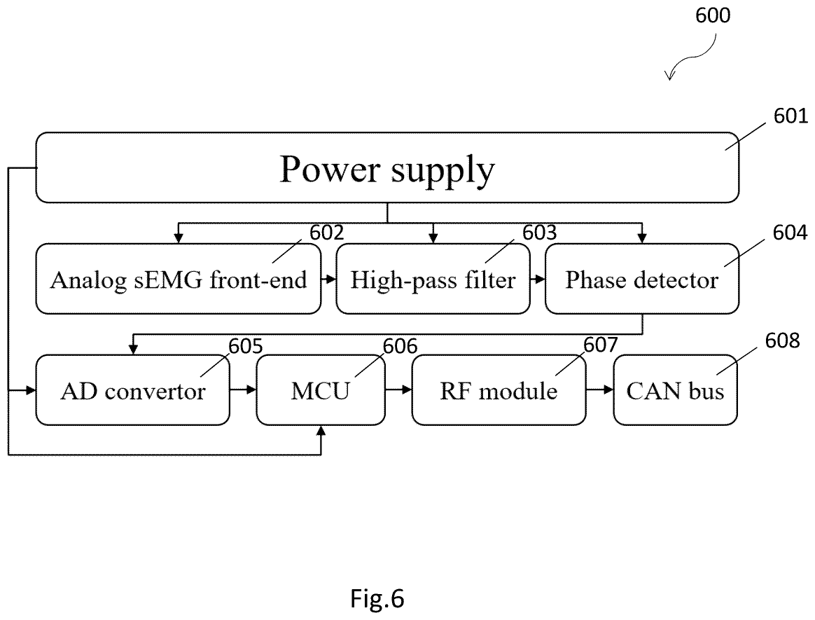

The hardware design of sensors mainly includes power management, front-end amplification circuit topology, back-end high pass filter design, phase comparator topology, wireless module design, AD conversion chip, and MCU. All modules will be integrated on the PCB circuit board. The specific circuit design of each module is shown in the FIG. 6.

In one example embodiment, the circuit design 600 of the sensor comprises power management includes a power supply 601 for supplying power to a plurality of modules. The front-end amplification circuit topology here is an analog sEMG front-end sensor 602 and the back-end high pass filter design here is a high pass filter 603. The phase comparator topology comprises a phase detector 604. The AD conversion chip forms an AD convert 605 which enables data collection and there is also provided a MCU 606 which enables data transmission and processing. The wireless module design includes a RF module 607 which enables wireless data transmission. Additionally, there is also provided a CAN bus 608 which enables reliable wired data transmission.

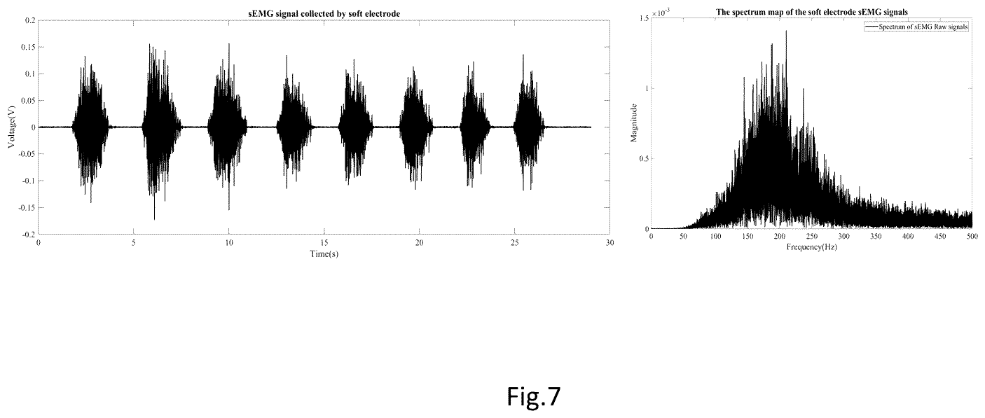

The sEMG signal was collected using the soft electrode proposed in the present invention, and spectral analysis was performed on the signal. The collected data and spectrum analysis are shown in the following figure. From FIG. 7, it can be seen that the present invention can effectively collect electromyographic signals.

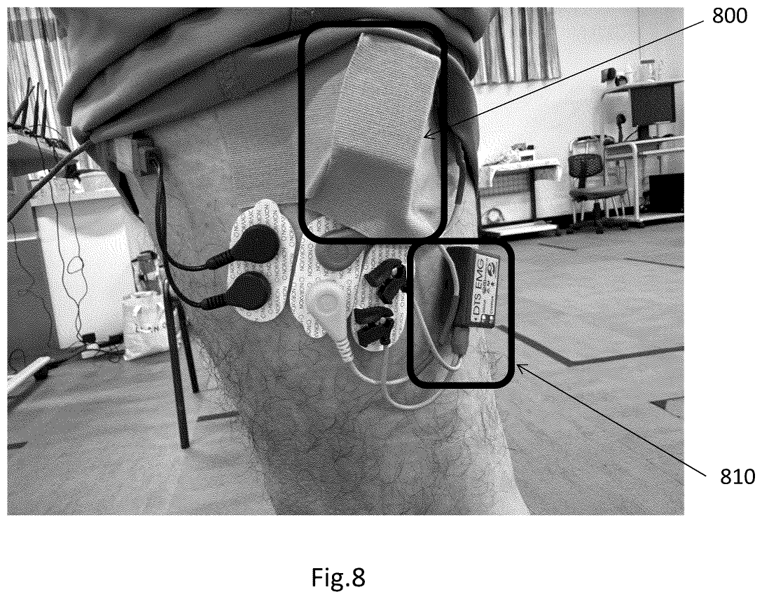

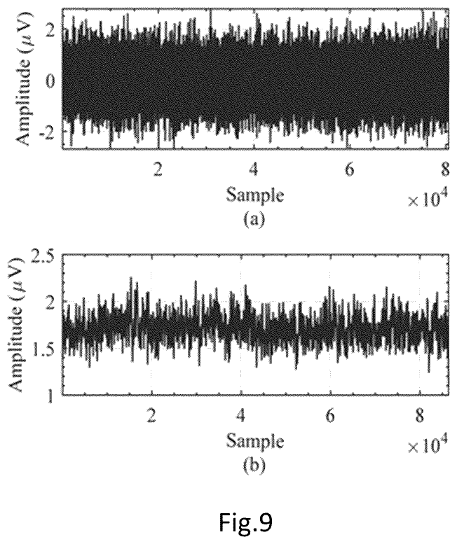

The wireless sEMG sensor 800 in accordance with one example embodiment of the present invention and a commercial wireless sEMG sensor 810 are shown in FIG. 8 respectively. The baseline noise of the two sensors 800, 810 is shown in FIG. 9.

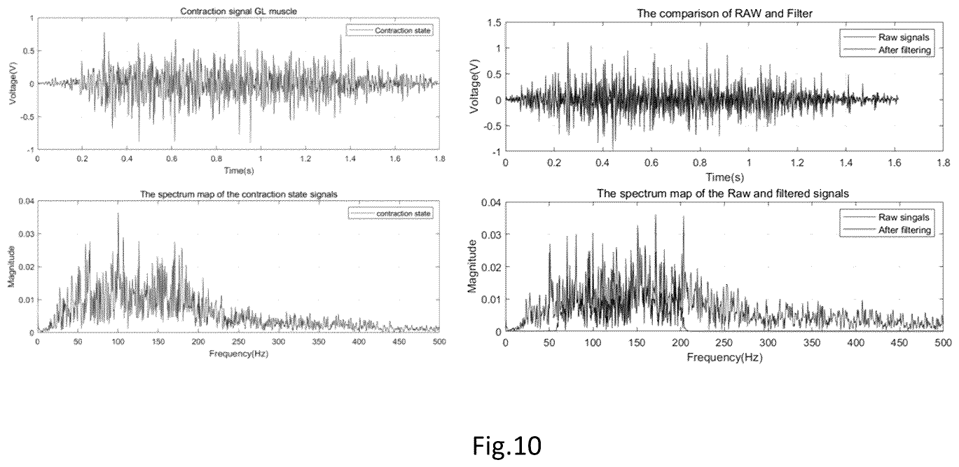

The signals from this sEMG sensor are collected by the muscle of gastrocnemius lateralis (GL). From the spectrum as shown in FIG. 10, it can be seen that the frequency distribution of the sEMG signal of GL muscle collected before digital filtering is mainly between 80-200 Hz, with a signal-to-noise ratio of approximately 21, which meets the sEMG signal requirements recommended by SENIAM.

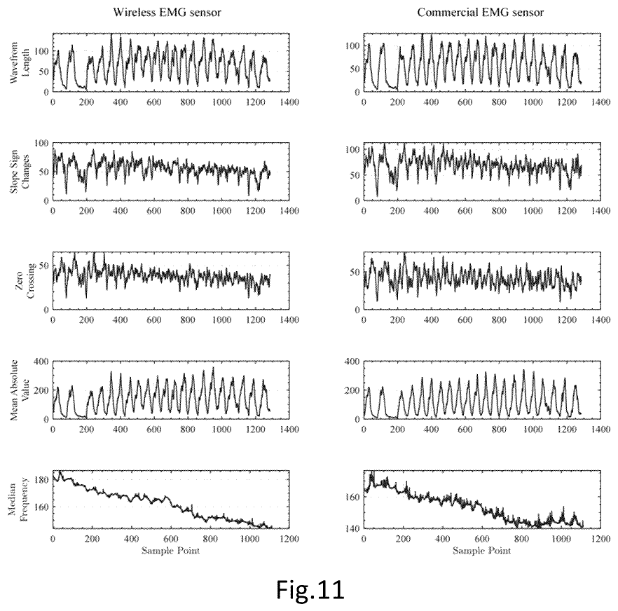

A comparison was made between the wireless sEMG sensor proposed by the present invention and the commercial EMG sensor. The compared parameters include VPP, VRMS, SC, and ICC as shown in FIG. 11. The comparison results are shown in the table below.

TABLE 2
VPP and VRMS of wireless EMG sensor
and commercial EMG sensor

| | Wireless EMG | Commercial |
|---|---|---|
| | sensor | EMG sensor |
| Vₚ₋ₚ | 5.6246 μV | 0.4191 μV |
| V_{RMS} | 0.6162 μV | 0.0217 μV |

TABLE 3
The average SC and ICC between wireless
EMG sensor and commercial EMG sensor

| | Wireless EMG − Commercial |
|---|---|
| | EMG |
| SC | 0.6156 |
| ICC | 0.7780 |

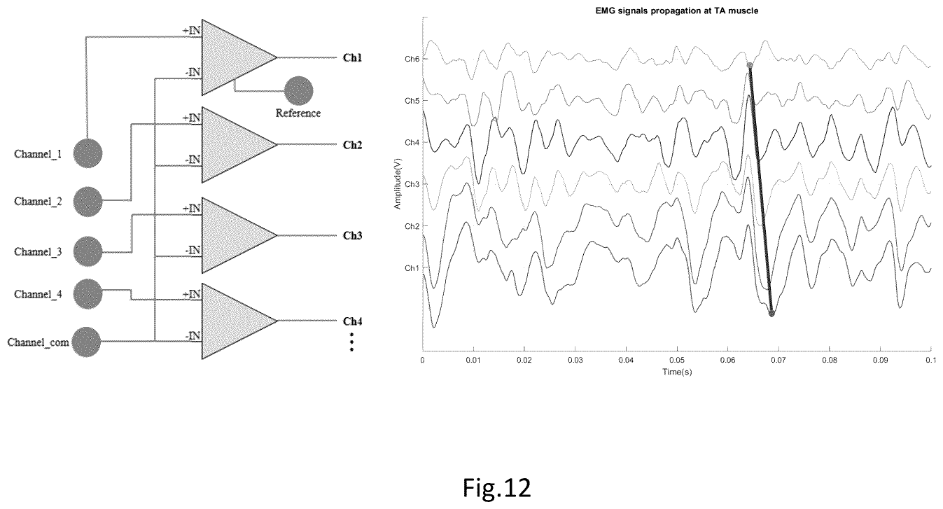

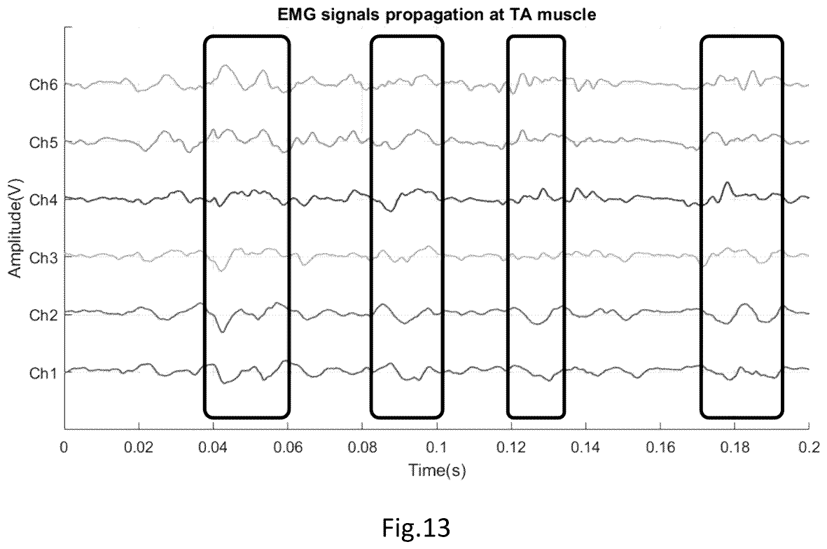

The sEMG signals of this linear array as shown in FIG. 12 were obtained unilaterally at the IZ position of the TA muscle. If the electrodes are symmetrically arranged on both sides of the IZ position, the opposite phase phenomenon should be observed in channels 1 and 6 as shown in FIG. 13.

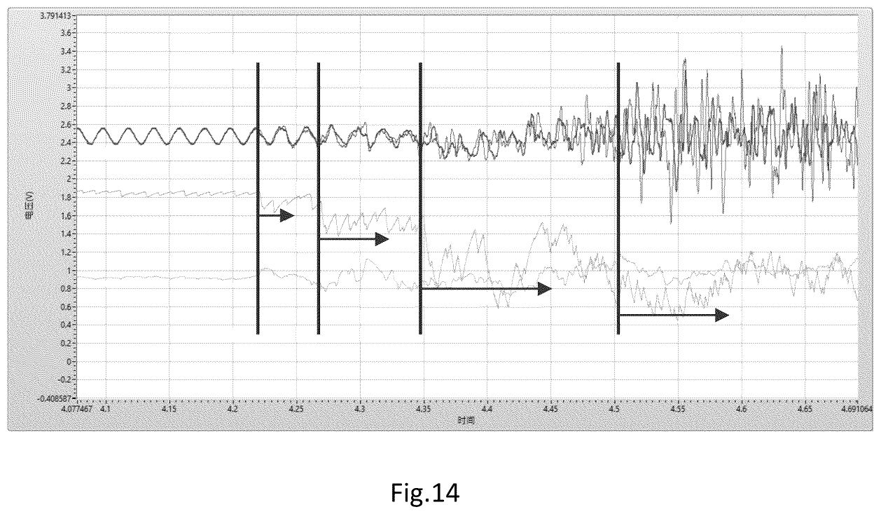

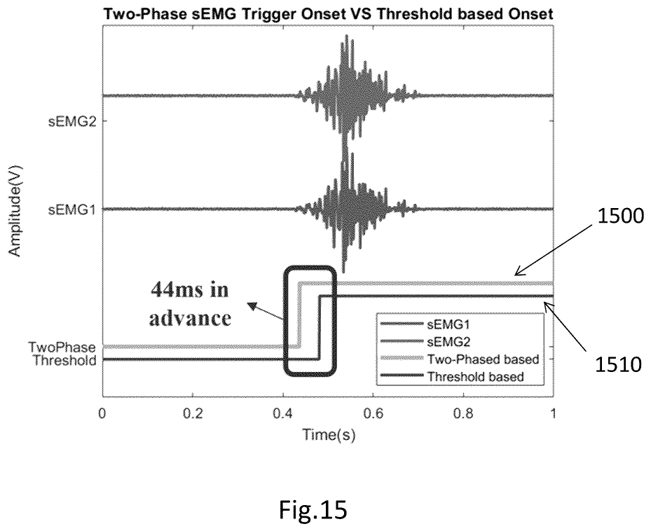

By utilizing the phase difference of the opposite phase sEMG signals for human motion intention detection as shown in FIG. 14, the MCU computing power required for Raw signal processing is avoided, and its feature is an inevitable phenomenon during muscle contraction, thereby improving the accuracy of detection. A comparison between the two-phase sEMG trigger onset 1500 and traditional threshold based onset 1510 is shown in FIG. 15.

The existing sEMG sensors mainly have the following drawbacks:

The first point is that electrodes used for sticking to the skin often require button connections, which increases the overall thickness of the electrodes. And the electrode has poor ductility, which can lead to electrode detachment when the skin undergoes significant deformation.

The inventors have proposed a thin and soft electrode that makes it softer and more comfortable to wear on the skin surface when collecting sEMG signals for the first drawback.

In terms of soft electrodes, the inventors used a 0.2 mm stretchable TPU material as the substrate and printed the circuit of the electrode on it to address the electrode issue. By connecting a 0.16 mm FPC to the printed circuit of the soft electrode, the thickness of the electrode itself and the buttons between the electrode and the wire are greatly reduced, resulting in an overall thickness of 300 microns. Because the characteristics of the entire electrode are thin and soft, it can fit the skin well and follow the stretching of the skin.

The second point is that although existing sEMG sensors can collect sEMG signals, they do not have the function of real-time judgment of muscle activation. The existing methods for determining muscle activation are based on a single channel threshold, which is susceptible to noise interference and has low robustness. The activation time of muscles often needs to be post-processed based on the already collected signals.

SEMG-Triggered Fast Assistance Strategy for a Pneumatic Back Support Exoskeleton relates to the use of sEMG to control robot motion. The target robot it needs to control is an exoskeleton with pneumatic back support. To implement its fast auxiliary strategy through sEMG trigger. However, its control still adopts the TKEO method, which uses a single channel sEMG to generate the control signal of the robot on through the TKEO operator and threshold method. Moreover, its signal needs to be transmitted wirelessly to the upper computer before making decisions, which can result in significant delays. Compared with this reference, the proposed method for detecting muscle onset in the present invention has significant advantages in terms of implementation and data transmission.

Teager-Kaiser Energy Operation (TKEO) of Surface EMG Improves Muscle Activity Onset Detection proposes the use of TKEO for muscle activity on set detection. The detection method proposed is based on a single channel sEMG signal. The TKE operator proposed still needs to use a threshold to make judgments when identifying an onset. The proposed method does not perform backend signal processing, making it difficult to achieve good results under the influence of noise. The algorithm proposed in this invention does not use hardware to achieve muscle activation on set detection. Based on the above points, there is a fundamental difference between the muscle onset detection method proposed in this literature and the present invention.

Regarding the issue of using sEMG for muscle activation detection, the present invention first designs an sEMG sensor as the front-end detection circuit for implementing the functions of the present invention. It utilizes a high-precision instrument operational amplifier to detect and amplify weak electromyographic signals, and eliminates other physiological signals such as crosstalk and low-frequency electrocardiogram signals through the common mode suppression characteristics of the precision operational amplifier. After the EMG signal passes through the analog front-end, there will still be some low-frequency environmental noise such as 50 Hz power frequency interference mixed in. Therefore, the present invention designs an analog back-end filter, which mainly performs high pass filtering based on the frequency distribution of the sEMG signal in the 80-350 Hz range, in order to obtain a relatively pure EMG signal.

Due to the phase difference in the propagation of electromyographic signals on muscles, opposite phase sEMG are used for real-time phase detection. When the muscle is in an inactive state, the phase difference between the opposite phase sEMG is zero or remains unchanged. When the muscle is in an activated state, the phase difference between the opposite phase sEMG is non-zero or changes. By utilizing this characteristic, it can accurately detect whether the muscle is in an activated state.

Because two sEMG signals are used to determine the muscle's offset point, the interference of common mode noise on the electromyographic signal can be eliminated, thereby improving the robustness of the sensor.

Through the two-phase difference detection technology, the inventors have solved the problem of muscle activation detection and can achieve real-time detection and transmission, while also having a certain ability to resist noise. This method uses the phase difference of signals from two channels to achieve muscle activation detection.

The third point is that existing sensors are often limited in communication interfaces and data transmission, which affects customized applications.

The inventors have proposed a dual-mode sensor for wireless and wired communication, giving it greater freedom in data transmission and storage to meet customized requirements. The inventors adopt a dual-mode solution of wireless and wired to address the issue of sensor data transmission and communication. The use of ADC chips enables data collection, MCU enables data transmission and processing, ESP32 microcontroller enables wireless data transmission, and CAN bus interface enables reliable wired data transmission. In this way, both the requirements for signal acquisition and storage, as well as communication with other controllers, can be met.

The novel elements of the present invention include but are not limited to:
1. a thin and soft electrode, which uses screen printing to make circuits, FPC and wire connections, and has comfortable wearing. It can stretch and have good contact with the skin.
2. Use of two sEMG sensors and matched phase comparators. The phase comparator can output the phase difference information of two sEMG signals and is used for muscle activation detection.
3. Sensors have wireless data transmission modules, CAN communication modules, and serial communication modules. Having these three modules simultaneously makes its application more convenient and expands its application scenarios.

The present invention pertains to a novel apparatus and method for real-time detection of muscle activation onset using phase-based surface electromyography (sEMG). The invention significantly departs from conventional techniques, which typically rely on bioimpedance changes, muscular response to transcutaneous electrical nerve stimulation (TENS), or anatomical localization such as uterine contractions or location of muscle fiber.

In one embodiment, muscle onset detection is achieved via sEMG signal acquisition based on phase properties, rather than amplitude or energy metrics. This method eliminates the need for bioimpedance differentiation or stimulation-induced response analysis as employed in existing solutions.

Advantageously, the signal measurement is performed using a phase-based sEMG approach, wherein the phase difference between two physiological signals from distinct anatomical locations is computed in real time. This differs fundamentally from prior art, which depends on calculating signal magnitude variations or comparing signal amplitude to fixed thresholds.

Furthermore, the invention comprises an analog hardware phase comparator circuit that performs an instantaneous analog comparison between phase-inverted sEMG signals. The comparator is directly coupled to a trigger generation module such as a zero-crossing detector which produces a binary output indicative of muscle activation onset.

Importantly, the system architecture omits digitization and complex computation, thereby minimizing latency and computational overhead. The analog implementation enables real-time response suitable for functional control applications.

The data processing methodology incorporated in this invention also utilizes analog circuit design, which is inherently distinct from digital signal processing methods or TENS-based digital modulation techniques present in conventional systems.

The trigger circuit operates in a largely threshold-independent manner, detecting a change in signal state e.g., specifically the crossing of a baseline rather than relying on a fixed amplitude threshold. This characteristic enhances robustness against signal noise and variability in contraction strength.

By eschewing the “calculate-then-compare-to-threshold” paradigm, the present invention introduces a new operational framework for muscle activation detection. This paradigm shift not only improves response speed but also enhances reliability and noise immunity.

The invention, therefore, represents a novel and non-obvious solution to the problem of high-latency muscle activation detection, introducing a phase-driven, analog hardware-based approach that redefines the state-of-the-art in neuromuscular signal processing and control.

Advantageously, the wireless sensor for muscle activation detection proposed by the inventors has great potential for application in various scenarios of human-machine collaborative assisted robots. This method is particularly suitable for those who experience muscle atrophy due to aging and require assistive devices, such as assistive robots. It is also applicable to patients who require rehabilitation training due to muscle injuries, including but not limited to stroke patients, amputees, etc. When these patients need to provide auxiliary strength training, the method of the present invention can be applied. In the field of sports and fitness, it can help trainees analyze the activation time of muscles and the difference in activation time of several muscles that need to cooperate with each other, so as to better guide training and improve performance.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

1. A muscle activation detection apparatus, comprising:
a first surface electromyogram (sEMG) sensor arranged to receive a first sEMG signal associated with a user;
a second sEMG sensor arranged to receive a second sEMG signal associated with the user; and
a processing unit configured to determine the muscle contraction of the user based on the first and second sEMG signals.

2. A muscle activation detection apparatus in accordance with claim 1, further comprising a phase comparator arranged to compare the phase difference between the first and second sEMG signals so as to determine the real-time muscle contraction.

3. A muscle activation detection apparatus in accordance with claim 2, wherein the muscle in an inactive state is represented by a the sEMG signals detected zero phase difference at the two sides of IZ and the muscle in an activated state is represented by the sEMG signals detected non-zero phase difference at two sides of IZ respectively.

4. A muscle activation detection apparatus in accordance with claim 2, wherein the relative distance between the first and second sEMG sensors on a muscle fiber is in a positive correlation with the phase difference between the first and second sEMG signals.

5. A muscle activation detection apparatus in accordance with claim 2, wherein the processing unit is configured to transmit an output signal associated with a force or torque parameter of a robot device based on the determined degree of muscle contraction.

6. A muscle activation detection apparatus in accordance with claim 5, wherein the ON-OFF control of the robot device is determined based on the start and end of the determined muscle contraction.

7. A muscle activation detection apparatus in accordance with claim 1, wherein the sEMG sensor further comprises a soft electrode arranged to physically contact the skin surface of the user.

8. A muscle activation detection apparatus in accordance with claim 1, further comprising an amplifier configured to amplify electromyographic signal to a measurable level.

9. A muscle activation detection apparatus in accordance with claim 1, further comprising a high pass filter configured to perform high pass filtering on the sEMG signal.

10. A muscle activation detection apparatus in accordance with claim 1, further comprising a wireless radio frequency module configured to control a remote robot device.

11. A muscle activation detection apparatus in accordance with claim 1, further comprising a CAN chip module configured to control a remote robot device by wire.

12. A muscle activation detection apparatus in accordance with claim 1, further comprising a serial communication module to monitor the data and transfer the data to a remote robot device.

13. A muscle activation detection apparatus in accordance with claim 2, further comprising a trigger generating unit in signal communication with the phase comparator and the trigger generating unit is configured to trigger a robot device based on the output from the phase comparator associated with the compared phase difference between the first and second sEMG signals.

14. A muscle activation detection apparatus in accordance with claim 13, wherein the trigger generating unit further comprises a mixer configured to mix the first and second sEMG signals to generate a mixed output signal.

15. A muscle activation detection apparatus in accordance with claim 14, wherein the trigger generating unit is configured to detect a change in the mixed output signal corresponding to an onset of muscle activation.

16. A muscle activation detection apparatus in accordance with claim 15, wherein the trigger generating unit is configured to generate a binary trigger signal in response to a detected change in the mixed output signal.

17. A muscle activation detection apparatus in accordance with claim 16, wherein the binary trigger signal is indicative of a transition from an inactive muscle state to an activated muscle state.

18. A muscle activation detection apparatus in accordance with claim 17, wherein the trigger generating unit is configured to perform a zero-crossing detection on the mixed output signal to generate the binary trigger signal.

19. A muscle activation detection apparatus in accordance with claim 1, further comprising a linear electrode arranged to detect an IZ location and a location in contact with a preamplifier of the sEMG sensor.

20. A muscle activation detection apparatus in accordance with claim 19, wherein the linear electrode further comprises a linear electrode array formed by the first sEMG sensor and the second sEMG sensor and arranged to be placed along a length of the muscle.

21. A muscle activation detection apparatus in accordance with claim 20, wherein the linear electrode comprises multiple sEMG sensors spaced from each other at a uniform distance.
